(19) United States
(12) Patent Application Publication
(10) Pub. No.: US 2004/0128969 A1
(43) Pub. Date: Jul. 8, 2004

(54) Mower accessory for attachment to a front end of a skid-steer loader

(76) Inventor: Robert Meurer, Chippewa Falls, WI (US)

Correspondence Address: MANELLI DENISON & SELTER, 2000 M STREET NW SUITE 700, WASHINGTON, DC, 20036-3307, US

(21) Appl. No.: 10/633,032

(22) Filed: Aug. 4, 2003

Related U.S. Application Data
(60) Provisional application No. 60/432,642, filed on Dec. 12, 2002.

(51) Int. Cl. A01D 34/00

(52) U.S. Cl. 56/229

(57) ABSTRACT

A mower accessory is constructed and arranged to be coupled to a front end of skid steer loader. The skid steer loader has a body and front and rear wheels. At least the rear wheels are constructed and arranged to cause driving movement of the skid steer loader. The skid steer loader has a lift structure constructed and arranged to move accessories when coupled thereto. The mower accessory includes a caster structure constructed and arranged to be removably coupled to the lift structure at the front end of the skid steer loader. The caster structure has at least one caster mounted for rolling and swiveling motion. A mower deck coupled to the caster structure and has at least one mower blade. When the mower accessory is coupled to the skid steer loader and the lift structure is moved generally downwardly with respect to the body, the caster is constructed and arranged to engage the ground causing the front wheels of the skid steer loader to raise so as not to engage the ground. Thus, during mowing, with the front wheels out of ground engagement, damage to the ground is minimized.

This application is based on U.S. Provisional Application No. 60/432,642, filed on Dec. 12, 2002 and claims the benefit thereof for priority purposes.

### FIELD OF THE INVENTION

This invention relates to all wheel drive skid-steer loaders and, more specifically, to lawn mower accessory having caster structure such that when coupled to a skid-steer loader and in an operative position, the caster structure engages the ground as front wheels while the front wheels of the skid steer loader are raised so as to not engage the ground.

### BACKGROUND OF THE INVENTION

All-wheel or rear wheel drive skid-steer loaders have gained in popularity due to their compact size and maneuverability. The conventional skid-steer loaders are configured so that a variety of attachments may be coupled thereto, such as a pallet fork, a box scraper attachment, a dozer blade, etc. One problem in using such loaders is that since they have a small turning radius and may turn very quickly, the driving wheels tend to rip-up sod or grass or may damage the surface upon which they are operating. This unacceptable when a lawn mower is to be coupled to the skid steer loader.

Accordingly, there is a need to provide a mower accessory for a skid steer loader that is attachable to the front of the skid steer loader and prevents or minimizes damage to the surface upon which the loader is operating.

### SUMMARY OF THE INVENTION

An object of the invention is to fulfill the need referred to above. In accordance with the principles of the present invention, this objective is obtained by providing a mower accessory constructed and arranged to be coupled to a front end of skid steer loader. The skid steer loader has a body and front and rear wheels. At least the rear wheels are constructed and arranged to cause driving movement of the skid steer loader. The skid steer loader has a lift structure constructed and arranged to move accessories when coupled thereto. The mower accessory includes a caster structure constructed and arranged to be removably coupled to the lift structure at the front end of the skid steer loader. The caster structure has at least one caster mounted for rolling and swiveling motion. A mower deck is coupled to the caster structure and has at least one mower blade. When the mower accessory is coupled to the skid steer loader and the lift structure is moved generally downwardly with respect to the body, the caster is constructed and arranged to engage the ground causing the front wheels of the skid steer loader to raise so as not to engage the ground. Thus, during mowing, with the at least rear driven wheels.

The conventional skid steer loader 12 also includes a lift structure typically formed by a pair of lift arms 30 mounted to a body 32 of the steer loader 12. Front end mounted accessories such as the mower accessory 12, can be removably mounted to the lift arms 30 by means of a mount 34. The mount 34 is conventional and can be considered to be part of the lift structure. The lift arms 30 are raised and lowered with respect to the body 32 by lift and tilt cylinders 38 associated with each lift arm 30. As shown in FIG. 3, a separate or secondary hydraulic system including a constant displacement pump 40 is used to actuate the lift arms via the cylinders 38 which are actuated through movement of separate foot pedals 42 mounted toward the front of operator's compartment as is known in the art.

In accordance with the invention, the mower accessory 10 includes a caster structure. In the illustrated embodiment, the caster structure includes a pair of spaced frames 44, each having one end constructed and arranged to be removably coupled the mount 34 at the front end of the skid steer loader 12. The other end of each frame 44 includes a caster 46 mounted thereto for rolling and swiveling motion. It can be appreciated that only one centrally disposed frame 44 can be provided instead of the pair of illustrated frames.

A mower deck 48 having at least one conventional rotary mower blade 50 (FIG. 3) is coupled to the frames 44 of the caster structure and is constructed and arranged to cut grass. A pair of actuators 56 is provided to raise and lower the mower deck with respect to the frames 44 to adjust the height of the blade 50 with respect to the ground (e.g., the grass cutting height). In the embodiment, the actuators 56 are hydraulic cylinders coupled between the frames 44 and the mower deck 48 and operated by a hydraulic line 52 that is fluidly connected to the pump 40 of the skid steer loader and operated by lever 57 (FIG. 3). It can be appreciated that the actuators 56 can be electrically operated actuators if desired. Furthermore, the mower deck 48 carries a hydraulic motor 58 operated by pump 40 via line 54 to cause rotation of the grass cutting blades 50.

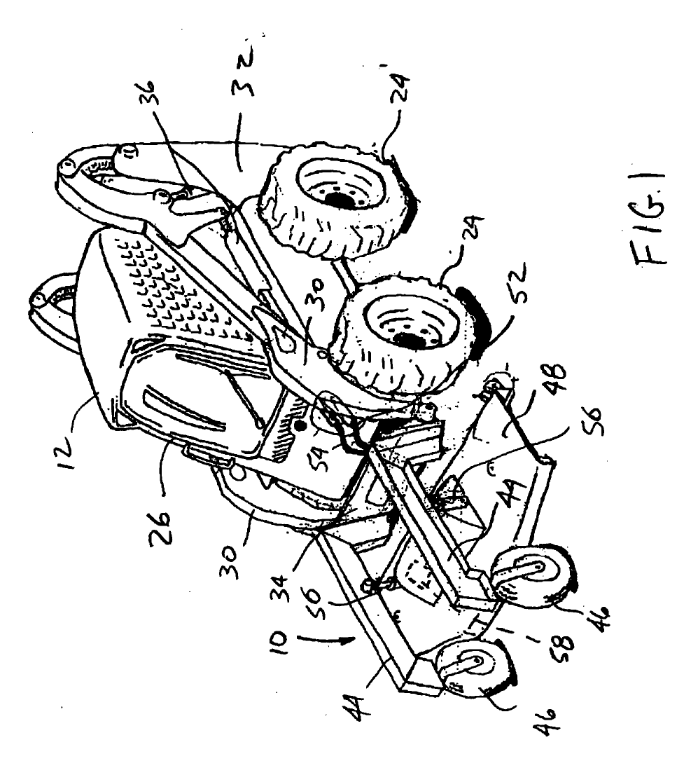

As shown in FIG. 1, when the mower accessory 10 is coupled to the skid steer loader and the lift arms 30 are move generally downwardly, the casters 46 engage the ground causing the front wheels 24 of the skid steer loader to raise so as not to engage the ground, with only the rear wheels 24′ driving the loader 12. Thus, while mowing with the front wheels 24 out of ground engagement, damage to the ground is minimized. When the lift arms 30 are moved generally upwardly (not shown), the casters 46 move from ground engagement causing the front wheels 24 of the skid steer loader to lower so as to engage the ground, returning the skid steer loader to a normal operating position will all four wheels of the skid steer loader engaging the ground.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A mower accessory constructed and arranged to be coupled to a front end of skid steer loader, the skid steer loader having a body and front and rear wheels, at least the rear wheels being constructed and arranged to cause driving movement of the skid steer loader, the skid steer loader having a lift structure constructed and arranged to move accessories when coupled thereto, the mower accessory comprising:
a caster structure constructed and arranged to be removably coupled to the lift structure at the front end of the skid steer loader, the caster structure having at least one caster mounted for rolling and swiveling motion, and
a mower deck coupled to the caster structure and having at least one mower blade,
wherein when the mower accessory is coupled to the skid steer loader and the lift structure is moved generally downwardly with respect to the body, the caster is constructed and arranged to engage the ground causing the front wheels of the skid steer loader to raise so as not to engage the ground.

2. The mower accessory of claim 1, wherein the mower deck is coupled to the caster structure via at least one actuator so that the mower deck can be moved towards and away from the caster structure to thereby control a height of the mower blade with respect to the ground.

3. The mover accessory of claim 2, wherein the actuator is a hydraulic cylinder.

4. The mower accessory of claim 1, wherein the caster structure includes a pair of spaced frames, each frame having one end constructed and arranged to be removably coupled to the lift structure, another end of each frame including a caster.

5. The mower accessory of claim 4, wherein the mower deck is coupled to each frame via an associated actuator so that the mower deck can be moved towards and away from the caster structure to thereby control a height of the mower blade with respect to the ground.

6. The mower accessory of claim 5, wherein each actuator is a hydraulic cylinder.

7. The mower accessory of claim 1, wherein the mower deck carries a hydraulic motor constructed and arranged to cause rotation of the mower blade.

8. A skid steer loader assembly comprising:
a body,
a pair of front wheels mounted with respect to a front portion of the body,
a pair of rear wheels mounted with respect to a rear portion of the body,
a primary hydraulic system for driving at least the rear wheels,
a lift structure constructed and arranged to move accessories when coupled thereto,
a secondary hydraulic system for moving the lift structure, and
a mower accessory comprising:
a caster structure removably coupled to the lift structure at the front end of the skid steer loader, the caster structure having at least one caster mounted for rolling and swiveling motion, and
a mower deck coupled to the caster structure and having at least one mower blade,
wherein when the lift structure is moved generally downwardly with respect to the body, the caster is constructed and arranged to engage the ground causing the front wheels of the skid steer loader to raise so as not to engage the ground.

9. The assembly of claim 8, wherein the mower deck is coupled to the caster structure via at least one actuator so that the mower deck can be moved towards and away from the caster structure to thereby control a height of the mower blade with respect to the ground.

10. The assembly of claim 9, wherein the actuator is a hydraulic cylinder associated with the secondary hydraulic system.

11. The assembly of claim 8, wherein the caster structure includes a pair of spaced frames, each frame having one end constructed and arranged to be removably coupled to the lift structure, another end of each frame including a caster.

12. The assembly of claim 11, wherein the mower deck is coupled to each frame via an associated actuator so that the mower deck can be moved towards and away from the caster structure to thereby control a height of the mower blade with respect to the ground.

13. The assembly of claim 12, wherein each actuator is a hydraulic cylinder associated with the secondary hydraulic system.

14. The assembly of claim 8, wherein the mower deck carries a hydraulic motor associated with the secondary hydraulic system and constructed and arranged to cause rotation of the mower blade.
